(19) United States
(12) Patent Application Publication
(10) Pub. No.: US 2006/0032015 A1
(43) Pub. Date: Feb. 16, 2006

(54) Wheel lock for casters

(76) Inventor: Louis A. Wyman, Phoenix, MD (US)

Correspondence Address: Evans & Molinelli PLLC, 6411 Chapel View Road, Clifton, VA, 20124, US

(21) Appl. No.: 10/917,126

(22) Filed: Aug. 12, 2004

(51) Int. Cl. B60B 33/00

(52) U.S. Cl. 16/45

(57) ABSTRACT

The present invention is directed to a simple, inexpensive wheel lock suitable for use with many single or multiple wheel casters. Generally speaking, a known conventional caster has an integrally formed frame including a caster holder that has a curved fender and one or two wheels positioned below the curved fender. A wheel lock according to an embodiment of the present invention is a curved piece of semi-rigid material that fits tightly enough into the space between the fender and the wheel to prevent the wheel from rolling. The wheel lock can be made to have an optional tab on the outer edge that permits easy positioning of the wheel lock and facilitates its removal.

### BACKGROUND OF THE INVENTION

1. Field of the Invention

The present invention relates to casters, specifically to a lock for furniture casters.

2. Description of the Related Art

Caster assemblies are widely known and commonly used in many industries. Caster assemblies may be grouped as swivel or rigid based depending on the type of movement they permit. Swivel caster assemblies allow multi-directional movement of the frame through which they are affixed to a supported article. Rigid caster assemblies enable only linear movement of the frame through which they are attached to a supported article.

A caster assembly is typically composed of one or more wheels mounted on a swivel frame for the support and movement of the supported article such as a movable cart, piece of furniture, trolley or gurney on which the assembly is installed. In a typical swivel caster assembly such as one attached to the leg of a chair, a load-supporting base member secured to the base of the leg has a vertical axle projecting from it on which one end of a swivel frame is pivoted. Mounted below the other end of the frame is a ground-engaging caster wheel rotatable on a horizontal axle.

When a chair has attached to each of its legs a conventional swivel caster assembly, each caster wheel swivels about a vertical axle projecting from the leg of the chair to assume an orientation in which the horizontal axis of rotation of the wheels is normal to the chosen direction of chair movement. Hence as the chair advances in the chosen direction, the caster wheels on the legs rotate freely.

Often it is desirable to prevent the wheels from rotating once the article, such as a piece of furniture, has been placed in a location where it is intended to remain for a length of time. Swivel caster assemblies can be outfitted with a swivel locking assembly which, when activated, restricts the pivoting movement of the assembly and thereby transforms it to a rigid caster assembly. Some swivel and rigid casters are designed to include wheel locks to prevent the wheel(s) from rolling. Some swivel casters have a combination of swivel lock and wheel lock features.

Traditional central locking casters comprise a wheel mounted on a fork, the fork having a sleeve that houses a plunger or push rod, and a mushroom-shaped breaking member mounted on the bottom of the plunger or push rod that engages the perimeter of the wheel in order to lock it. Many alternative braking mechanisms have been designed for casters. U.S. Pat. No. 3,914,821 to Screen, for example, discloses a foot-operated brake linked to a brake shoe that engages an inner surface of the roller. Another patent to the same inventor, U.S. Pat. No. 4,747,180, discloses a braking system for a caster comprising a cam-activated brake rod able to extend all the way to the floor to prevent movement. U.S. Pat. No. 5,014,391 to Schulte discloses a brake lever bearing a sharp-toothed brake member that interacts with a brake rim. U.S. Pat. No. 4,550,808 to Folson discloses a caster having a foot-operated brake lever that acts against a link, which in turn acts against a brake shoe comprising two side arms or flanges that “actually dig into” the inside surface of the outer cylindrical flange of the caster wheel. There is also a caster wheel designed in particular for bariatric beds that utilizes a push rod that acts upon a spring-loaded brake arm bearing sharp teeth to mate against an inner surface of the roller wheel.

The conventional wheel locking mechanisms described above are complicated and therefore expensive; consequently, most casters sold do not have either swivel or wheel locks. There is thus a need for an inexpensive wheel lock that can be sold or provided with casters.

### SUMMARY OF THE INVENTION

The present invention is directed to different embodiments of a wheel lock for a caster having one or more wheels, and to methods for making the wheel lock. The typical caster has a caster holder provided with a curved fender having a length L, a wheel having a width W positioned below the curved fender of the caster holder, and defining a space having a height H between the curved fender and the wheel. In one aspect of the present invention a wheel lock is made of a curved piece of semi-rigid material having an outer edge and an inner edge, a width w that is equal to or less than W, and a length that is equal to or less than L. The wheel lock fits snugly into the space of height H between the curved fender and the wheel thereby preventing the wheel from turning. The wheel lock can be made of a curved piece of semi-rigid material that is uniform in thickness. Alternatively, the wheel lock can be made from a curved piece of semi-rigid material that has an inner edge having a thickness that is less than the height H of the space defined between the curved fender and the wheel of the caster, and an outer edge that has a thickness that is greater than the height H.

In some embodiments, the wheel lock is made of bendable plastic. The wheel lock can also be made from other bendable, semi-rigid materials including cork or cardboard. In some embodiments, a wheel lock is made to have a tab protruding from its outer edge to make inserting and removing the wheel lock easier.

One method of making a wheel lock for a caster includes selecting a tube of semi-rigid material having a thickness that is about equal to height H of the space between the curved fender and the wheel of the caster, and a circumference that is about equal to or less than the length L of the curved fender. The tube is then sliced longitudinally along its full length to create a slit tube. The slit tube is then opened to produce a curved sheet. The sheet is then sliced many times in a direction perpendicular to its long axis into pieces having a width that is equal to or less than the width W of the wheel, thereby creating the wheel lock.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a perspective drawing that illustrates a furniture caster with a wheel lock according to an embodiment;

FIG. 1B is a block diagram that illustrates a side view of the caster with a wheel lock, according to an embodiment;

FIG. 2 is a block diagram that illustrates a wheel lock having a uniform thickness according to an embodiment;

FIG. 3 is a block diagram that illustrates a cross section of a wheel lock having a non-uniform thickness according to an embodiment;

FIG. 4 is a flow chart of a method of making a wheel lock according to an embodiment; and

FIGS. 5A and 5B are block diagrams that illustrate a method of making a wheel lock according to some embodiments.

### DETAILED DESCRIPTION

The present invention is illustrated by way of example, and not by way of limitation, in the figures of the accompanying drawings and in which like reference numerals refer to similar elements. Most pieces of heavy furniture sold today, such as couches and arm chairs, have simple swivel casters that do not include wheel or swivel locks, primarily because such locks are too expensive to provide unless there is a serious need. For example, heavy airline carts used to serve food come equipped with wheel brakes because they could cause serious harm if they were to roll when unattended or when the airplane encounters turbulence. Likewise, hospital gurneys typically have wheel brakes to prevent the gurney from rolling when transferring a patient from the gurney to the bed.

Furniture on casters without wheel locks placed in homes or offices can shift position with use. Sometimes this shifting can be particularly hazardous, such as when an elderly or injured person is lowering himself or herself (with or without assistance) from a standing to a sitting position in a chair or on a couch that moves during the lowering. Normal everyday use of furniture on casters causes furniture to shift position. While not necessarily creating a danger, such shifting is often unsightly, necessitating a homemaker to realign the furniture.

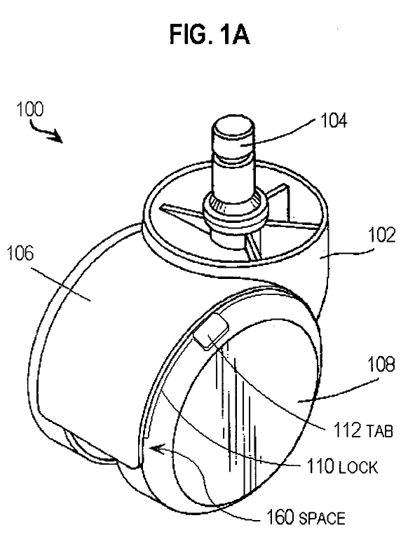

The present invention is directed to a simple, inexpensive wheel lock suitable for use with many single or multiple wheel casters. Generally speaking, a known conventional caster as shown in FIG. 1 has an integrally formed frame 100, including a caster holder 102 provided with a curved fender 106. A spindle 104 is disposed at a top of the caster holder 102 and one or two wheels 108 positioned below the curved fender 106 of the caster holder. A wheel lock 110 according to an embodiment of the present invention depicted in FIG. 1 is a curved piece of semi-rigid material that fits tightly enough into the space 160 between the fender 106 and the wheel 108 to prevent the wheel from rolling. The wheel lock may be inserted over one or both wheels of a two-wheel caster. The wheel lock 110 in the illustrated embodiment further comprises an optional tab 112 that permits easy positioning of the wheel lock 110, and facilitates its removal.

FIG. 1B shows a side view of the caster having a fender 106, a wheel 108, a space 160 between the fender and the wheel, and a wheel lock 110 inserted into the space 160. In the embodiment shown in FIG. 1B the wheel lock has an optional tab 112.

The height H of the space between the fender 106 and the wheel 108 of a typical furniture caster is approximately 0.2 cm. It has been discovered that a piece of semi-rigid malleable (i.e., bendable) plastic can be used to make a wheel stop. In a preferred embodiment, the plastic wheel stop is made of bendable clear plastic having a thickness approximately equal to or slightly greater than the height H of the space between the fender 106 and the wheel 108 of a typical furniture caster, a length about equal to or less than the length L of the curved fender, and a width w about equal to or less than the width W of the wheel.

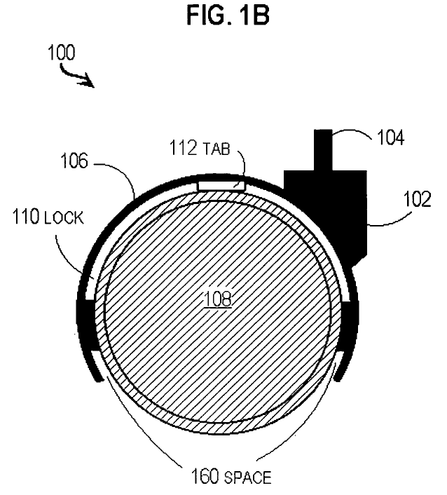

FIG. 2 shows the wheel lock in detail. The width w 236 of the wheel lock is about equal to or less than the width W of the wheel(s). The wider the wheel lock, the greater friction there is to prevent the wheel from rolling. In most embodiments the width is greater than about ¼ the width W of the wheel. The length 234 of the wheel lock is about equal to or less than the length L of the caster fender; the longer the wheel lock, the greater friction there is to prevent the wheel from rolling. In most embodiments the length of the wheel lock is greater than about ¼ of the length L of the fender. The length and width w are chosen to produce enough friction to keep the wheel from rolling under normal stress. A person of skill in the art can determine a thickness, width and length of semi-rigid material for use as a wheel lock without undue experimentation. The most critical measurement is the height H of the space between the fender and the wheel, which determines the thickness of the wheel lock; this is because the wheel lock must fit snugly into this space 160 in order to create enough friction to prevent the wheel from rolling. The width and length of the wheel lock are less critical and therefore can vary more.

Strong, bendable plastic is the preferred embodiment for the semi-rigid material to be used to fashion the wheel lock 110 because it works very well, is readily available, and is inexpensive and durable. However, other semi-rigid materials that can be bent to fit the curve of the space between the fender 106 and the wheel 108, and that provide enough friction when inserted into the space 160 to prevent the wheel from rolling can also be used. Such semi-rigid materials include but are not limited to cardboard, cork, or rubber. Clear, colorless plastic is preferred because it automatically matches the color of the caster and thus does not detract from the aesthetic appeal of a furniture piece using the caster.

FIG. 2 shows a wheel lock 210 having a uniform thickness. An optional tab 212 protrudes from the outer edge 214 of the wheel lock 210. In other embodiments the tab 212 is omitted; and in some such embodiments the outer edge of the lock is uniform. The inner edge 216 of the wheel lock 214 is the edge that is inserted into the space between the fender and the wheel (106 and 108, respectively, in FIG. 1).

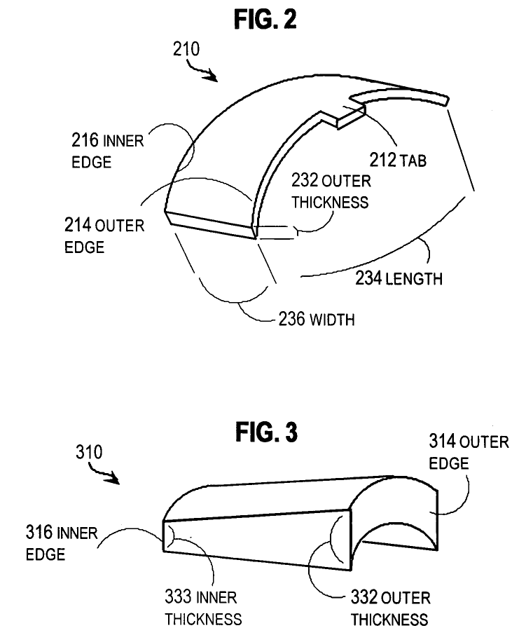

In another preferred embodiment illustrated in FIG. 3 the wheel lock is designed for easy insertion into the space between the fender 106 and the wheel 108. In this embodiment, the wheel lock 310 has an outer edge 314 with an outer thickness Ho 332 that is substantively greater than the height H of the space between the fender and the wheel. It also has an inner edge 316 that has an inner thickness Hi 333 that is substantively less than the height of the space between the fender and the wheel. The narrow inner thickness permits the wheel lock to be inserted into the space more easily than if the inner thickness Hi 333 of the lock were about equal to the thickness H of the space. The non-uniform thickness wheel lock also has the additional advantage that it fits a greater variation among casters that have different spaces between the fender and the wheel than a wheel lock that has a uniform thickness. In this embodiment it is preferred that the change in thickness from the inner edge 316 to the outer edge 314 is gradual so that there is still sufficient friction to hold the wheel lock tightly against the fender and the wheel to prevent rolling.

The tab (212 in FIG. 2) is optional, though it is used in a preferred embodiment for easy insertion and removal of the wheel lock. The tab can be formed as part of the wheel lock, for example, when the wheel lock is formed from an injection mold. Alternatively, a tab can be attached to a curved wheel lock after the lock has been made. This can be accomplished, for example, by using an adhesive tape or glue.

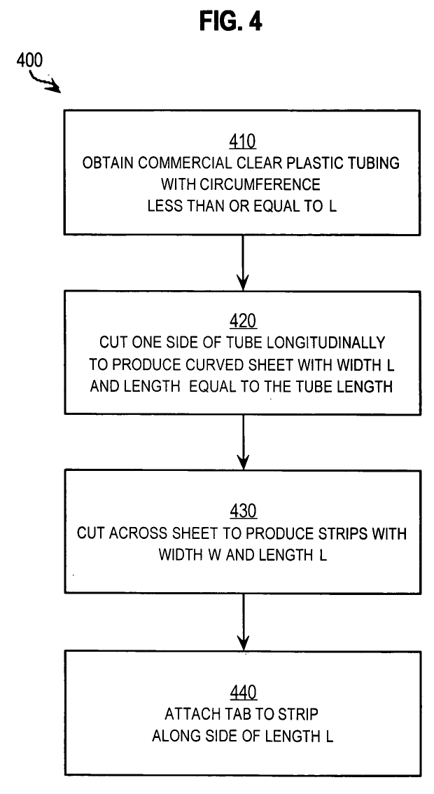

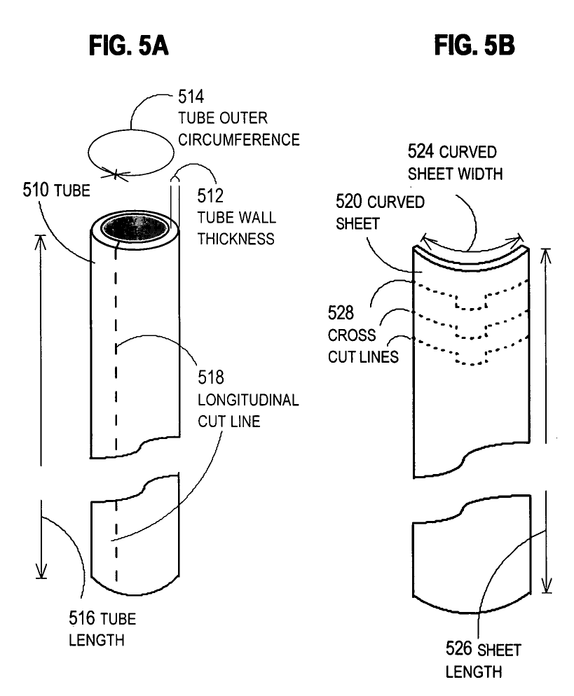

The wheel lock 210 having a uniform thickness can be manufactured easily and cheaply using a tube of malleable, bendable plastic as is described in FIG. 4 and illustrated in FIG. 5. Step 410 involves selecting the proper commercial clear plastic tube such that: 1) it has tube walls with the desired thickness 512 (FIG. 5A) that is approximately equal to the thickness of the height H of the space between the wheel and the fender; 2) it has a circumference 514 (FIG. 5A) that is suitable for a length, equal to or less than the length L of the outside edge of the fender; and 3) it can be bent (after being sliced as described below) to form a curved sheet 520 (FIG. 5B) that has the desired curvature needed to fit into the space between the fender and the wheel.

According to step 410 of this method of manufacture, the tube is cut one time longitudinally to produce a curved sheet. FIG. 5A shows the tube with longitudinal cut line 518 running the length 516 of the tube. After the tube is cut longitudinally, it is opened to form a curved sheet 520 depicted in FIG. 5B.

In some embodiments, a curved clear plastic sheet is obtained in lieu of a clear plastic tube; and step 410 is omitted. For example a clear plastic chair guard can be used as the curved plastic sheet 520, and step 410 can be omitted. A suitable curved clear plastic sheet is available from Plastic Glide Manufacturer in Rancho Durango, Calif. 90220 as part no. 875326-1-trim sleeve protector.

In step 430, the curved sheet is then cut crosswise many times, shown in FIG. 5B as cross cut lines 528. The cross cuts are perpendicular to the length of the sheet. The distance between cross cuts is equal to the width w of the wheel lock. The length of the wheel stop is determined by the curved sheet width 524. The curved strips thus produced form the wheel lock of the present invention. A tab may be optionally included along the side of length L (step 440) as is shown in FIG. 5B. A die or shaped cutting tool can be used to make the crosscuts in the curved sheet to form a one-piece wheel lock with a tab on the outer edge. In other embodiments, the cross cuts are straight and do not form a tab. A tab may then be omitted or attached in a separate step, not shown. If a series of cross cuts are made along cross cut lines 528 depicted in FIG. 5B, each wheel lock will have a tab on the outer edge, and a notch on the inner edge as is indicated by the cross cut line 528 in FIG. 5B. The size of the tab can be chosen such that the notch does not interfere with the ability of the wheel lock to stop the wheel from rolling once it is inserted into the space between the fender and the wheel.

In other embodiments, the wheel lock, either a wheel lock with uniform thickness or a wheel lock as depicted in FIG. 3 having a non-uniform thickness, is formed in a mold as a single piece.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A wheel lock for a caster comprising a caster holder provided with a curved fender having a length L, a wheel having a width W positioned below the curved fender of the caster holder, and defining a space having a height H between the curved fender and the wheel, the wheel lock comprising a curved piece of semi-rigid material having an outer edge and an inner edge, a width w that is equal to or less than W, and a length that is equal to or less than L, wherein the wheel lock fits snugly into the space of height H between the curved fender and the wheel thereby preventing the wheel from turning.

2. The wheel lock of claim 1, wherein the thickness of the curved piece of semi-rigid material is uniform.

3. The wheel lock of claim 1, wherein the inner edge of the curved piece of semi-rigid material has a thickness that is less than the height H of the space defined between the curved fender and the wheel of the caster, and the outer edge of the curved piece of semi-rigid material has a thickness that is greater than the height H of the space.

4. The wheel lock of claim 1, wherein the caster has a single wheel.

5. The wheel lock of claim 1, wherein the caster has two wheels.

6. The wheel lock of claim 1, wherein the semi-rigid material is plastic.

7. The wheel lock of claim 1, wherein the semi-rigid material is clear plastic.

8. The wheel lock of claim 1, wherein the semi-rigid material is selected from the group comprising cork or cardboard.

9. The wheel lock of claim 1, further comprising a tab protruding from the outer edge of the wheel lock.

10. A method of making a wheel lock for a caster comprising a caster holder provided with a curved fender having a length L, a wheel having a width W positioned below the curved fender of the caster holder, and defining a space having a height H between the curved fender and the wheel, the method comprising
selecting a tube of semi-rigid material having a thickness that is about equal to height H of the space between the curved fender and the wheel of the caster, and a circumference that is about equal to or less than the length L of the curved fender,
slicing the tube longitudinally along its full length to create a slit tube, and
slicing the slit tube perpendicular to its long axis into pieces having a width that is equal to or less than the width W of the wheel thereby creating the wheel lock.

11. A method of making a wheel lock for a caster comprising a caster holder provided with a curved fender having a length L, a wheel having a width W positioned below the curved fender of the caster holder, and defining a space having a height H between the curved fender and the wheel, the method comprising
selecting a curved sheet of semi-rigid material having a thickness that is about equal to height H of the space between the curved fender and the wheel of the caster, and a circumference that is about equal to or less than the length L of the curved fender, and
slicing the curved sheet of semi-rigid material perpendicular to its long axis into pieces having a width that is equal to or less than the width W of the wheel thereby creating the wheel lock.
